(19) United States
(12) Patent Application Publication
(10) Pub. No.: US 2009/0190359 A1
(43) Pub. Date: Jul. 30, 2009

(54) LED LIGHT STRING SYSTEM

(75) Inventor: Zhaoyuan LI, Heyuan City (CN)

Correspondence Address: TROUTMAN SANDERS LLP;BANK OF AMERICA PLAZA, 600 PEACHTREE STREET, N.E., SUITE 5200, ATLANTA, GA, 30308-2216, US

(73) Assignee: Cindex Holdings Limited (a Hong Kong corporation), Hong Kong (CN)

(21) Appl. No.: 12/360,273

(22) Filed: Jan. 27, 2009

Related U.S. Application Data
(60) Provisional application No. 61/024,009, filed on Jan. 28, 2008.

(51) Int. Cl. F21V 5/00; F21V 7/00

(52) U.S. Cl. 362/308; 362/311.01

(57) ABSTRACT

The light emitting diode (LED) light string system includes a plurality of lamp systems. Each lamp system includes a single LED, a base, and a globe to cover the LED. The LED light string system appears similar to the conventional incandescent light string system, but instead illuminates via LEDs. Each LED is covered by the globe similar to those available in incandescent systems, which provides refraction of the illuminated LED to produce an LED light string that has the look of a conventional incandescent light string.

### CROSS REFERENCE TO RELATED APPLICATION

This application claims benefit, under 35 U.S.C. §119(e), of U.S. Provisional Application Ser. No. 61/024,009, filed 28 Jan. 2008, the entire contents and substance of which are hereby incorporated by reference.

### BACKGROUND

Embodiments of the present invention relate to a light string system and, more particularly, a light emitting diode (LED) light string system.

Conventional light strings are known in the art. Conventional light strings are predominantly used during the holiday season for decorative purposes, e.g., Christmas tree lights, outdoor holiday lights, and icicles light sets. Conventional light strings commonly comprise a plurality of light systems that include conventional light sources, i.e., preferably incandescent light bulbs having filaments.

A rather recent development in the design of conventional light strings is to include light emitting diodes as a light source. Advantages of light emitting diodes over incandescent light bulbs include, but are not limited to, lower power consumption, longer lifespan, lower heat generation, smaller size and weight, robustness, faster switching time, and being available in a number of colors.

### SUMMARY

Briefly described, embodiments of the present invention include a light emitting diode (LED) light string system. The LED light string system has the look of the conventional incandescent light string systems, but illuminates via light emitting diodes instead.

In an exemplary embodiment, a lamp system for a light string system including a plurality of lamp systems. Each lamp system comprises a light assembly, a socket assembly, and a refractive assembly. The light assembly includes a light emitting diode. The socket assembly includes a socket dimensioned to receive via insertion a portion of the light assembly. Further, the socket assembly includes a pair of contacting members on opposing sides of the socket. The refractive assembly covers a majority of the light assembly enabling refraction of an illuminated light assembly.

These and other objects, features, and advantages of the present invention will become more apparent upon reading the following specification in conjunction with the accompanying drawings.

### BRIEF DESCRIPTION OF THE DRAWINGS

FIG. 1 illustrates a partial cross-sectional view of a lamp system for use in a light emitting diode (LED) light string system, in accordance with an exemplary embodiment of the present invention.

FIG. 2 illustrates a partial cross-sectional view of a light assembly illustrating exemplary refraction and reflection of an illuminated light emitting diode, in accordance with exemplary embodiments of the present invention.

### DETAILED DESCRIPTION

To facilitate an understanding of the principles and features of embodiments of the invention, they are explained hereinafter with reference to implementations in illustrative embodiments. In particular, embodiments of the invention are described in the context of being a light emitting diode light string system.

Embodiments of the invention, however, are not solely limited to use as a light emitting diode light system. Rather, embodiments of the invention can be used wherever a circuit or other system with an illuminating characteristic is needed or desired.

The material described hereinafter as making up the various elements of the present invention are intended to be illustrative and not restrictive. Many suitable materials that would perform the same or a similar function as the materials described herein are intended to be embraced within the scope of the invention. Such other materials not described herein can include, but are not limited to, materials that are developed after the time of the development of the invention, for example.

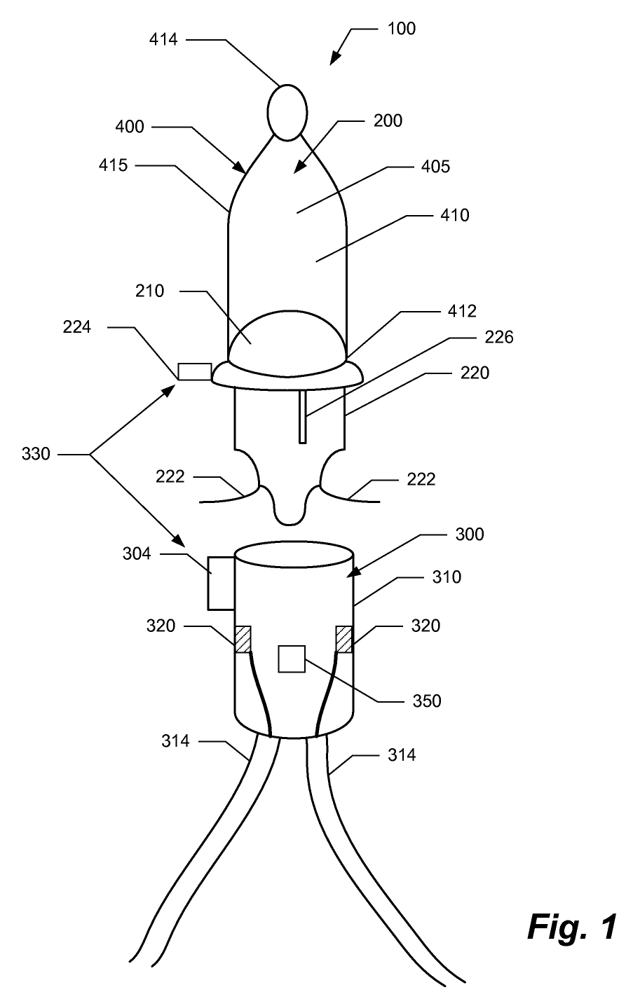

Referring now in detail to the figures, FIG. 1 is a partial cross-sectional view of an exemplary embodiment of a lamp system for use in a light emitting diode (LED) light string system. The LED light string system comprises a plurality of lamp systems 100 connected to one another, in either parallel or series, wherein each lamp system 100 comprises a light assembly 200, a socket assembly 300, and a refractive assembly 400. Each light assembly 200 comprises an LED 210 and a base 220 in communication with the LED 210. Each socket assembly 300 comprises a socket 310 adapted to receive a portion of the light assembly 200. Each refractive assembly 400 can partially or fully encapsulate the light assembly 200 including the LED 210 to provide brilliant refraction of an illuminated light.

The light assembly 200 of the lamp system 100 comprises the LED 210 and the base 220 in communication therewith. The LED 210 is adapted to illuminate when energized. In an exemplary embodiment, conductors can be in electrical communication with the LED 210. The conductors enable energy to the LED 210 for illumination purposes. The conductors of the LED 210 can extend down through the base 220, wherein exemplarily the conductors can be in communication with a pair of lead wires 222 external the base 220. In one embodiment, the conductors and the lead wires 222 can be the same wire/conductor. The lead wires 222 extend through a bottom of the base 220, and are a pair of wires that can be wrapped around the base 220 extending upwardly in the direction of the LED 210, adjacent the base 220.

The light assembly 200 further includes the base 220. The base 220 can be integrally formed with the LED 210. The base 220 can be a unitary element of the LED 210, or a separate element. Exemplarily, the base 220 communicates between the LED 210 and an associated socket 310, complimenting and facilitating the seating of the light assembly 200 to the socket 310.

In an exemplary embodiment, the base 220 can incorporate at least one ridge 226 to ensure a snug fit with the socket 310, preventing the accidental disengagement of the light assembly 200 from the socket assembly 300. Other mechanical mechanisms can be used with the base 220 and the socket assembly 300 to ensure a tight fit.

Each socket can include contacting members 320 on opposing sides for interacting and being in electrical communication between the wires 222 of the LED 210 and the wires 314 between the lamp systems 100.

In an exemplary embodiment, the light assembly 200 can further comprise a locking assembly 330 to secure the light assembly 200 to the socket assembly 300. The locking assembly 330 may be exterior, or designed within the socket assembly 300 to fasten and/or couple the connection of the light assembly 200 to the socket assembly 300 internally. In an exemplary embodiment, the locking assembly 330 is external and can include cooperating light assembly elements 224 and socket assembly element 304. These elements 224 and 304 can be formed as a clasp and a lock to insert the clasp. For example, the base 220 of the light assembly 200 can include the element 224 that extends approximately normal to the base 220 and can define an aperture. On the other end of the locking assembly 330 can be the element 304, which extends outwardly from the socket 310, and can be inserted into the element 224 of the base 220. As the element 304 of the socket 310 is inserted into the element 224 of the base 220, the locking assembly is complete. In another example, the clasp can be coupled to the base 220 of the light assembly 200 and the receiving portion can be coupled to the socket 310; as a result, the element 304 can define the aperture to receive the element 224.

Stringent Underwriters Laboratories (UL) requirements recently require that lights and sockets fit tightly together; this requirement may ultimately decrease the value of the locking assembly 330 in the lamp system 100. Advantageously, the improvement in injection molding machines now enables the production of sockets and lamp assemblies that have a tight, snug fit.

Wires 314 connect lamp system 100 to one another, in either electrical series or electrical parallel relationship. The lead wires 222 of the light assembly 200 are in electrical communication with the wires 314, such that power flowing through the wires 314 can be transferred to the lead wires 222 and thus activate the LED 210. For example, one of the lead wires 222 is in communication with one of the contacting member 320, which is in communication with the wire 314; the same can be true for the opposing lead wire 222.

Light strings, such as the decorative light string system disclosed herein, are typically arranged with lamp systems 100 being electrically connected in series, rather than in a parallel arrangement. Unfortunately, there are disadvantages to designing a light string in series. When even a single light assembly is removed from a socket assembly, the entire series of lights is rendered inoperable. Because each light assembly within its respective socket completes the electrical circuit, when a light assembly is removed or the filament of the bulb burns out, a gap is created in the circuit; that is, an open circuit is formed. Thus, electricity is unable to continue to flow through the circuit.

To overcome this dilemma, in an exemplary embodiment, the socket assembly 300 can include a shunting device 350 to enable the energy flowing through the light string system to continue to flow even when a light assembly 200 is absent from the socket 310. For example and not limitation, the light string will remain illuminated even though there may exist: for example, a faulty light emitting diode, faulty socket, or simply because the LED is not properly mounted in its respective socket, or is entirely removed or falls out of its respective socket. For instance, the bypass activating system described in Massabki et al., U.S. Ser. No. 11/849,423, filed Sep. 4, 2007, the entire disclosure of which is incorporated herein by reference, can be used as the shunting device 350 herein.

The refractive assembly 400 can include a refraction layer 405 to protect the LED 210 of the light assembly 200. In an exemplary embodiment, the refraction layer 405 can be a globe 410 for covering most, if not all, of the LED 210. The globe 410 is in communication with, and terminates at the base 220. The globe 410 comprises an open bottom end 412, such that the open bottom end 412 is in communication with a top portion of the base 220, and a closed top end 414. The open bottom end 412 can receive and encapsulate a portion of the LED 210. As a result, the LED 210 is protected from harsh elements, including inclement weather (e.g., water) and other debris.

The globe 410 can be made of conventional translucent or transparent material such as plastic, glass, and the like. The globe 410 defines a hollow interior enabling protection of and receiving the LED 210. Unlike other LED light string systems, the globe 410 provides the look of conventional incandescent light systems. Further, unlike conventional incandescent-based light strings, if the globe 410 were to break, the LED 210 will remain illuminated and protected.

The globe 410 can be either removably attached to the base of the light assembly or alternatively permanently attached. The globe 410 can be provide protection the LED 210, such that the LED 210 and the interior of the base 220 and the socket 310 are further protected from its elements, including being waterproof.

In addition, the globe 410 can refract or change the direction of light emitting from an illuminated LED 210. Unlike conventional LEDs, which illuminate more like a spotlight and fail to illuminate light in a large direction, the globe 410 enables the LED 210 to appear and thus illuminate as a conventional light source having a filament. For example and not limitation, by incorporated the globe 410, the LED 210 can now shine up to 270 degrees, rather than in a single directed direction.

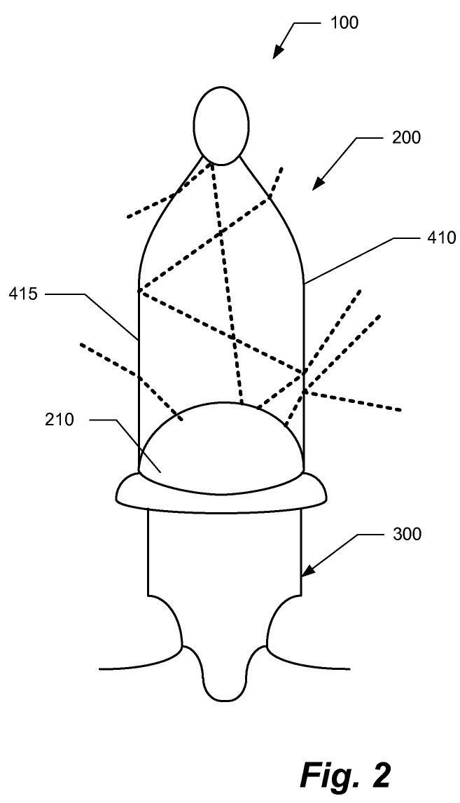

Exemplarily, as shown in FIG. 2, when the globe 410 covers an illuminated LED 210, light from the LED 210 not only illuminates upwardly, but also partially about the sides 415 of the globe 410. The closed top end 414 of the globe 410 not only refracts the light, but also reflects the light to back within the hollow cavity, as illustrated by the exemplary light paths shown in FIG. 2. Likewise, the sides 415 of the globe 410 can also reflect the light about and within the hollow cavity.

While the invention has been disclosed in its exemplary forms, it will be apparent to those skilled in the art that many modifications, additions, and deletions can be made therein without departing from the spirit and scope of the invention and its equivalents, as set forth in the following claims.

What is claimed is:

1. A lamp system for a light string system comprising a plurality of lamp systems, each lamp system comprising:
a light assembly comprising a light emitting diode;
a socket assembly comprising a socket dimensioned to receive via insertion a portion of the light assembly, the socket assembly including a pair of contacting members on opposing sides of the socket; and
a refractive assembly covering a portion of the light assembly enabling refraction of an illuminated light assembly.

2. The lamp system of claim 1, the refractive assembly comprising a refractive layer having an open bottom end and a closed top end and defining a hollow cavity for encapsulating the portion of the light assembly.

3. The lamp system of claim 1,
the light assembly further comprising a base;
the socket of the socket assembly dimensioned to receive a portion of the base of the light assembly; and
the refractive assembly comprising a refractive layer having an open bottom end and a closed top end and defining a hollow cavity for encapsulating a portion of the light assembly.

4. The lamp system of claim 3, the refractive layer of the refractive assembly comprising a globe having the shape of a conventional light globe for an incandescent light bulb for a light string.

5. The lamp system of claim 3, the refractive layer adapted to change the direction of light illuminated from the LED.

6. The lamp system of claim 4, the refractive layer enabling the LED to shine up in a direction of up to 270 degrees.

7. The lamp system of claim 4, the refractive layer adapted to reflect illuminated light from the LED back within the hollow cavity of the refractive assembly.

8. The lamp system of claim 4, the refractive layer enabling the LED to illuminate in a manner similar to a conventional incandescent light bulb.

9. A lamp system comprising:
a light emitting diode;
a socket dimensioned to receive via insertion a portion of the light emitting diode, the socket having an inner cavity that includes a pair of contacting members on opposing sides of the socket; and
a refractive assembly covering a majority portion of the light assembly enabling refraction of an illuminated light assembly, and comprising a refractive layer having an open bottom end and a closed top end and defining a hollow cavity for encapsulating the majority of the light assembly.

10. The lamp system of claim 9,
the socket dimensioned to receive a portion of a base of the light emitting diode; and
the open bottom end of the refractive assembly in communication with a portion of the base of the light emitting diode.

11. The lamp system of claim 9, the refractive assembly comprising both refractive and reflective characteristics.
